(19) United States
(12) Patent Application Publication
(10) Pub. No.: US 2008/0273978 A1
(43) Pub. Date: Nov. 6, 2008

(54) Vertical axis omni-directional wind turbine

(76) Inventor: Philip G. Watkins, Torrance, CA (US)

Correspondence Address: DONALD D. MON;ATTORNEY AT LAW, SUITE 303, 750 EAST GREEN STREET, PASADENA, CA, 91101, US

(21) Appl. No.: 11/797,203

(22) Filed: May 1, 2007

(51) Int. Cl. F03D 3/06

(52) U.S. Cl. 416/197 A

(57) ABSTRACT

A vertical axis wind turbine with a rotor driven by a group of vanes that assure starting at low speeds, efficiently generates electricity at all wind speeds, especially under circumstances that include abrupt increases in the wind velocity.

### FIELD OF THE INVENTION

Vertical axis omni-directional axis wind turbines with enhanced efficiency of wind stream energy and reliability of starting from rest.

### BACKGROUND OF THE INVENTION

Wind driven turbines are generally divided into two classes on the basis of the orientation of their axis of rotation. The preponderance of major wind turbine installations have their axis horizontal, facing into the wind, often with propeller type blades. These are frequently seen in large “farms” in canyon passes and on mountainsides.

Horizontal axis turbines require substantial trunnions and related mechanisms to face the turbine into the wind. The simple Aeromotor windmill is a classical example. It has a tail fin that exerts a torque to center the axis into the wind. These have decorated the farming landscape for decades, especially for pumping water from wells. As a source of modest amounts of energy for very localized usage, it has a well-deserved reputation, but it has fallen into comparative disuse as electrical power grids have been established, and as power requirements have increased beyond the capacity of such small devices. What is suitable for keeping a small water tank full or cattle is ordinarily not sufficient to power a modern house.

The relatively enormous modern turbine installations and their related generators, placed in locations where the wind is strong, have deservedly taken over most of the market. Smaller installations cannot enjoy the benefits of long blades and of transmissions and generators which require substantial housings, all atop a very high and robust tower.

Among the very practical limitations of the modern horizontal turbine is the height of the tower required for ground clearance of the large propellers. If the ground clearance is minimized, then so is the diameter of the blade system and the frontal area of the rotor system. These conditions are profound limits when one considers providing electrical energy for installations such as homes and small shops where ground clearances are of critical importance.

It is an object of this invention to provide a wind turbine suitable for smaller installations, which is omni-directional, which starts reliably in slow winds, and which is very efficient, particularly in faster windstreams. This is accomplished with the use of a remarkably efficient vane according to this invention.

It is another object of this invention to provide a wind turbine in modular sections that can be stacked to provide any desired level of power outputs.

### BRIEF DESCRIPTION OF THE INVENTION

The wind turbine of this invention includes a rotor having a central axis of rotation, and a mount that supports the rotor for rotation around a vertical axis through a bearing or family of bearings. A plurality of vanes is supported by the mount, individually by respective arms, or mounted to a rim that is supported by the arms.

The vanes are directed tangentially to the circular path on which they are supported, so that each vane makes a full rotation around its own centroid as it makes a full rotation around the central axis. In this sense the rotor is omni-directional. The reactive force of an airstream from one direction is the same as the force when the airstream impinges from any other direction.

The vanes are all identical. Each has an axis, and is preferably mounted to the arm or to the rim tangentially. Each vane has a leading edge, a rounded nose at the leading edge, a dimension of height parallel to the axis of rotation, and a trailing edge. The term “tip speed” is used occasionally in this specification to describe the speed of the vane as a body. This speed is tangential to the path of the vanes.

The rounded nose extends to lips on each side of the vane, within which respective curved coves are formed, which blend into trailing faces that meet and terminate at the trailing edge of the vane.

An electrical generator is directly coupled to the rotor so as to be driven by it. The generator is preferably, although not necessarily, a permanent magnet type which is rigidly coupled to the rotor.

According to a preferred but optional feature of this invention, the vane is so configured that when coupled to the generator, it will exhibit a substantially linear energy output that is limited by system parameters such as generator counter-EMF, bearing loads, and aerodynamic cleanliness of the vanes. The rotor will not run away. Importantly, when an abrupt acceleration by way of a substantial burst of wind occurs near the terminal velocity at lower speeds, this turbine abruptly speeds up and persists at a higher rotary velocity while the higher wind speed prevails, this provides a higher energy output under conditions when it is most needed, such as in cold and wind storms. Speeds in this condition are also terminally limited relative to the existing parallel.

The above and other features of this invention will be fully understood from the following detailed description and accompanying drawings, in which:

### BRIEF DESCRIPTION OF THE DRAWINGS

FIG. 1 is a top view of the presently preferred embodiment of a wind turbine according to this invention;

FIG. 2 is a side view of FIG. 1 taken at line 2-2 therein;

FIG. 3 is a top view of a vane in FIG. 1; and

FIG. 4 is a schematic view showing the relationships of the vanes to an incident airstream at various positions around the central axis.

### DETAILED DESCRIPTION OF THE INVENTION

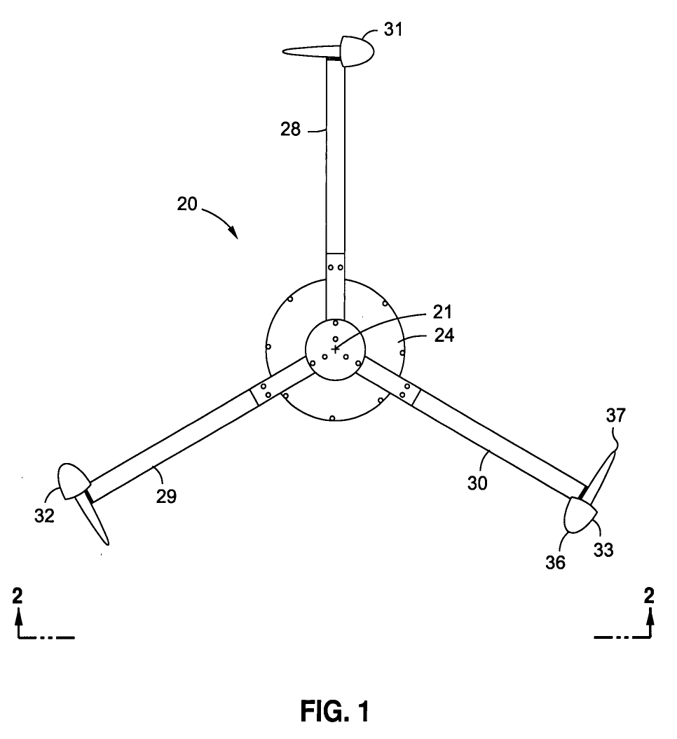

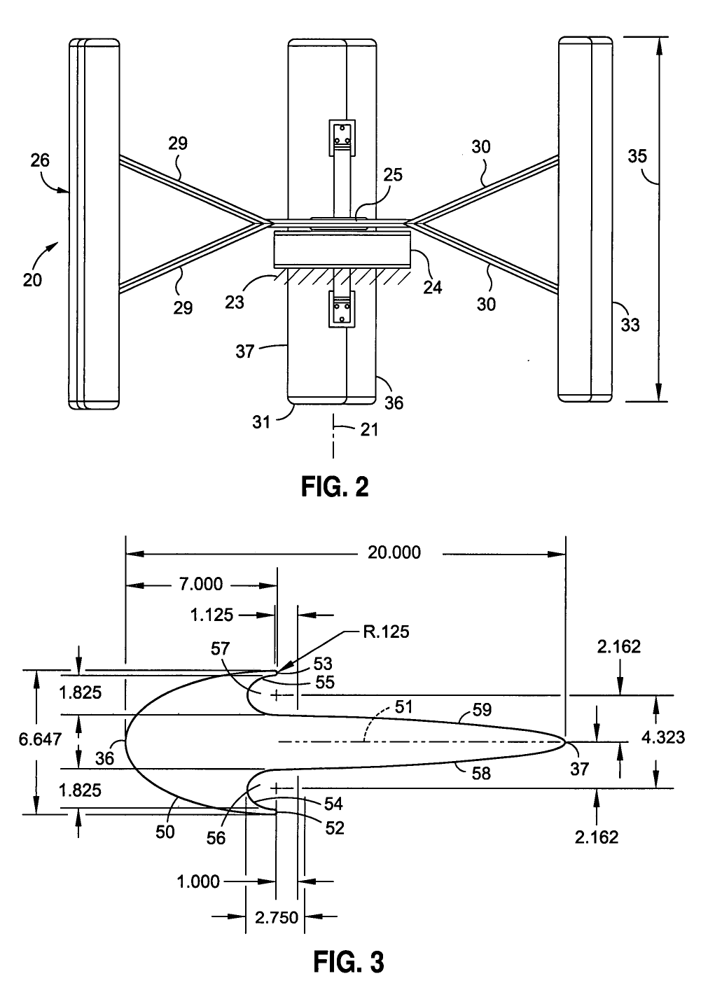

FIGS. 1 and 2 show a wind turbine 20 with a central axis of rotation 21 intended to stand vertically. As an example of its simplest and preferred structure, it is supported on a base 23 to which generator 24 is mounted. A bearing 25 supports rotor 26 and is directly connected to the rotor of the schematically-shown electrical generator so rotation of the rotor 26 drives the generator. Bearing 25 mounts two sets of three arms 28, 29, 30 each, one set above the other.

Vanes 31, 32, 33 are rigidly fixed to the ends of respective arms 28, 29, 30. While a rotor with only two vanes will function, it is subject to undesirable vibrations at some speeds. An odd number of vanes is to be preferred, and is illustrated. Use of odd numbers of vanes improves the starting reliability of the turbine at slower wind speeds.

The vanes are all identical. Each has a dimension 35 of height, a leading edge 36, and a trailing edge 37. In FIG. 1 the same vane is portrayed in three orientations. The rotor rotates around the central axis, traveling in the clockwise (positive) direction as shown in FIG. 1.

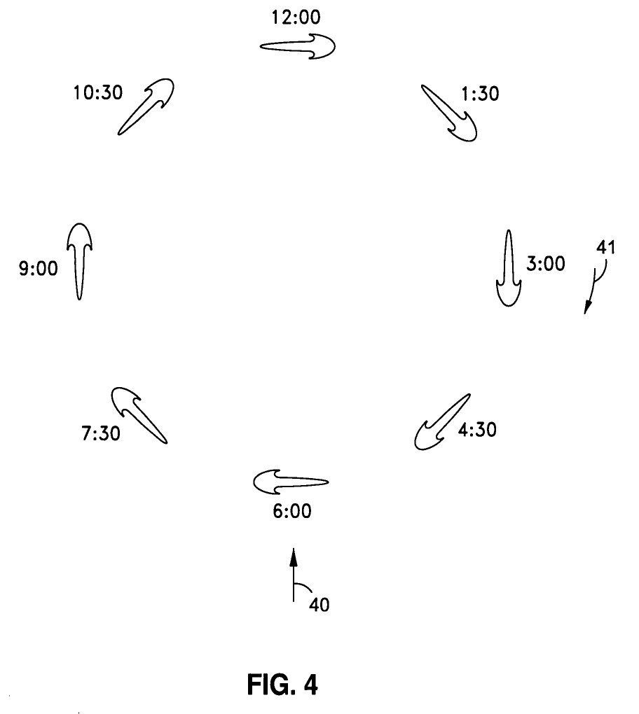

FIG. 4 is a schematic view disclosing the position of any of the vanes when in the illustrated locations. For convenience in explanation, the illustrative vane is shown in FIG. 4 at the following positions 12:00; 1:30; 3:00; 4:30; 6:00; 7:30; 9:00; and 10:30. Every vane goes through all of these positions (and all intervening positions) during each revolution, and itself makes a full revolution around its own centroid as it makes a complete turn around the central axis.

This is an omni-directional turbine. The same situation would exist when the wind blows from any direction around the “clock”. For convenience, in FIG. 1 a windstream 40 is shown confronting the rotor at 6:00. This is an arbitrary selection of direction of the incident airstream. As it transpires, the rotation of the rotor viewed from above will be clockwise as shown by arrow 41. In this system, leading edge 36 progresses downwardly while going between 12:00 and 6:00, and upwardly between 6:00 and 12:00. Of course this means that between 12:00 and 6:00 the leading edge moves into the windstream, and between 6:00 and 12:00 it moves with it.

The vane reacts differently with the windstream at its various orientations around the path. It is the objective of this invention that the net sum of the reactive force of the windstream against the vane from all of the vane positions is a positive torque. It should be remembered that the vanes are not only driven by the wind, but also are driven by the other vanes through the mount.

For this purpose the vane includes a number of specific shapes and dimension as best shown in FIG. 3. In that example, the height 35 is 10 feet, and the diameter of the rotor is 8 feet.

At its leading edge 36 the outer surface of the vane includes a bullet shaped nose 50 which is rounded in cross section across its own axis 51, The vane is symmetrical across the axis 51. The cross-section of the nose may be a circular or elliptical arc.

The nose extends rearwardly, to terminate at lips 52, 53. An inwardly concave surface 54, 55 at each side forms respective coves 56, 57. The cross-section curvature of the coves may be a circular arc.

Coves 56, 57 terminate at blade trailing faces 58, 59 which extend rearwardly to meet at trailing edge 37 of the vane. In the preferred embodiment shown, the blade is symmetrical across axis 57. The vane extends along an axis of height, dimension 35.

Faces 58, 59 are preferably shaped with a slight convexity as shown, rather than as a flat sheet, although a flat face will function reasonably well.

For convenience in discussion, lip 52 and cove 56 will be described as the “outer” lip and cove, and lip 53 and cove 57 as the “inner” lip and cove, because this will be their orientation when mounted to the rotor with the axis 51 of the vane tangential to the path of the vane around the central axis 21.

Suitable dimensions for the vanes used on the illustrated turbine shown are given on FIG. 3. Generally these may be scaled up or down, depending on the radial distance of the vane from the central axis of rotation on the size of the turbine, and on the number of vanes.

Discussion of the reactions of the vane will start at its six o'clock position and follow through the entire rotation, assuming that the wind is from the 6:00 toward axis 21. The direction of rotation will be clockwise, viewed from above, as shown by arrow 41. Because this is an omni-directional device, the discussion would be the same for wind coming from any other direction, relating to the direction from which it came.

In this example, in which it is assumed (FIG. 1) that there are three vanes 28, 29, 30, 120 degrees apart. With the turbine stopped, a vane at 6:00 will exert little if any torque. The turbine would be started by a vane between 6:00 and 12:00, because both of its coves “catch” the stream, along with some assistance from its blade. This guarantees that the turbine will start. AS a vane progresses from 6:00 to 12:00, wind force will be exerted on its outer face and cove, and some in the inner cove also. The least favorable position for starting, is when one of the vanes is at 6:00.

As a vane 28 passes toward 8:00 (see FIG. 4), it moves to expose inner cove 56 to the stream. At 9:00, both coves are fully involved, the rounded nose creating little resistance to movement of the vane through the airstream which drives it.

After 9:00, the blade gradually moves to blind the outer cove, but exposes its blade surface to the stream as it also deflects the stream into the inner cove. This positive torque persists until the 12:00 position is reached. There still is, however, some torque exerted by wind trapped in the inner cove.

The movement of the vane from 12:00 to 6:00 is less productive of positive torque than movement from 6:00 to 12:00, but from 12:00 to about 3:30 there is some. It is only between about 3:30 and 6:00 (vane 30 in FIG. 1) that at slow speeds there is only negligible clockwise torque from it, and perhaps some minor negative torque. However, it should be kept in mind that the vane at that time is being driven into the wind by the other vanes.

Resistance of the vane to the airstream as the vane moves from 12:00 is minimized by the curvature of the nose. There appears to be some turbulence developed in the coves at this time, which prevents the generation of negative pressure in them which would otherwise exert a restraining force and also generates a positive pressure in the coves. The result is a torque exerted on the vane at this time which before about 3:00 can contribute some driving force.

Between about 3:30 and 6:00 at low speeds the vane contributes little force to drive the rotor, and sometimes none. Instead it is driven into the windstream by the rotor structure with force derived from the other vanes, and by momentum of the system.

From the foregoing it will be observed that there is always a substantial net driving force derived from each full rotation of a vane, and that the turbine will always start. The above describes the basic action of this turbine.

Starting at very low wind speeds is assured by using an odd number of vanes, although with only two vanes starting is also reliable, but requires a somewhat higher wind speed. However, use of an even number of vanes often creates undesirable vibrations, which will not be generated when odd numbers of vanes are used. Therefore odd numbers of vanes are to be preferred.

In turbines of this type, the confronting net area of vanes as viewed in elevation as in FIG. 2 is of interest. Best operation is obtained when the wind directly strikes the vanes. Of course the wind is disrupted by other vanes when they cross the windstream ahead of it. creating turbulence, and also extracting energy ahead of the downstream vane.

This consideration is called “solidity”. As the net confronting area increases, the efficiency of the turbine decreases. Accordingly there should be a balance, and the best results are obtained with a very efficient vane such as the instant vane, with fewest number of vanes placed on larger diameter rotors. The vanes of this invention are uniquely effective, can readily be used with as few as three in number, with rotors of sizes that are attractive to home and business installations. The reduced solidity is evident.

One useful turbine system according to this invention, places the vanes of FIG. 3 about 4 feet from the central axis. It employs a permanent magnet generator. This turbine starts with a windstream as slow as about one mph, and generates power at rates relative to wind speed as follows:

| WIND SPEED (mph) | SURGE OUTPUT (KW) | |
|---|---|---|
| 10 | 441.0 | W |
| 20 | 2.5 | KW |
| 30 | 9.55 | KW |

This turbine is well-suited to be directly connected to an in-line electrical generator, and needs no rigid mechanical transmission or directional orientation. Different types of generators may instead be used. However, the permanent magnet type is especially suited to rural and isolated installation.

A wind turbine with vanes according to this invention exhibits a surprisingly improved productivity at higher wind speeds following an abrupt but common circumstance to be described. Generally speaking, the power output of a wind turbine is substantially linear up to its terminal rotational velocity, especially in the range of slower wind speeds up to about 12 mph. The terminal velocity in some normal ranges of wind speed is determined by a number of factors, prominently including bearing friction, aerodynamic consistency and cleanliness of the vanes, air density, the effects of counter-electromotive force (EMF) produced by the driven generator at higher rpms, and the negative force exerted on the leading edge of the vane by the windstream while it progresses from about 2:00 to 6:00.

Beyond this wind speed, the rotor does not greatly increase its rotational velocity with increased wind speed. It will not “run away”. However, there exists with this invention a surprising increase at higher wind speeds under certain circumstances.

Among the limitations of this rotor at slower speeds is the resistance or lack of contribution to the output of the vanes when they are between about 3:00 and about 6:00. The wind force confronting the vane at these positions exerts a limiting effect, and the tip speed of all vanes is therefore limited.

However, with this rotor and vanes if there is a sufficient surge in the wind speed, the force applied to the vanes in the other positions will exert a rapid accelerative force on all of the vanes, including the vane when between 3:00 and 6:00, abruptly increasing the tip speed (by driving the system) so that the vane in this “unproductive” arc exerts an aerodynamic lift that instantly contributes to the driving of the rotor, and overcomes the previous terminal velocity limitations.

Interestingly, previously described impediments, reject the wind resistance of the vanes when between 2:00 to 6:00, will limit the terminal velocity even at higher wind speeds. This limitation occurs in the example given in windstreams flowing up to about 17 mph. At this rotational velocity if there is a sudden gust, a sudden acceleration can occur. Then a tip speed acceleration of about 60 feet per second per second can be added to the existing approximately 17 mph velocity. This quickly accelerates the vane so that its tip speed ratio becomes between about 3.5-5.0:1. This overcomes the inefficiency of the vanes as they confront the windstream, and the forces exerted by the vanes between about 6:00 to about 1:00 are able to drive the confronting vanes between 1:00 and 6:00, and the vanes between about 3:00 to about 6:00 not only no longer are an impediment, but instead create a driving torque with their lift. The result is an almost instant increase in rotational velocity, potentially up to a new set of limits.

Surprisingly, this result will not result from a gradual increase in wind speed, but instead from gusts or other sudden wind surges. The higher speeds will continue so long as the faster wind speeds continue. If they decrease to below the previous rotor limit, the previous terminal limits will again be asserted.

During the time the increased velocity continues, the power generated is proportionally increased. This is very important condition because it is likeliest to occur when power is most needed, for example in cold-weather storms.

This turbine is simple in construction, and elegant in its performance. It is an affordable source of electricity, especially for systems of moderate demand.

This invention is not to be limited by the embodiment shown in the drawings and described in the description, which is given by way of example and not of limitation, but only in accordance with the scope of the appended claims.

I claim:

1. In a vertical axis wind turbine of the type having a vertical axis of rotation, a mount, a bearing on said mount and a rotor fixed to said bearing for rotation around the said vertical axis, a plurality of axially extending vanes fixed to said mount at a radial distance from said central axis, and spaced arcuately from one another, whereby wind impinging on the turbine from any direction will tend to drive the rotor, and an electrical generator fixed relative to the mount and functionally linked by the rotor to generate electricity, the improvement comprising:
each of said vanes having a dimension of length parallel to said central axis, a vane axis, and a uniform cross-section normal to said central axis and vane axis, said cross-section being characterized by an obtuse rounded nose at its leading edge, leading on each side of the vane axis to a terminal lip, an arcuately curved cove surface extending from said lip to a rearwardly-extending blade surface, said blade surface extending to the trailing edge of the vane, said cove surfaces fairing into said blade surfaces to create a cove between each said lip said covers extending forwardly of said lips, said blade surfaces extending rearwardly beyond said coves to provide surfaces for reaction with the windstream.

2. Apparatus according to claim 1 in which said cove surfaces are concave.

3. Apparatus according to claim 2 in which said cove surfaces are circularly arcuate in cross-section.

4. Apparatus according to claim 1 in which said blade surfaces are obtuse in cross-section.

5. Apparatus according to claim 1 in which said blade surfaces are planar.

6. In combination:
a plurality of said vanes, all parallel to said axis of rotation, and
a said generator rigidly connected to said rotor to be directly driven by said rotor.

7. A combination according to claim 6 which said generator is a permanent magnet type.

8. A combination according to claim 6 in which said vanes are odd in number, and are equally spaced from the axis of rotation and from their nearest adjacent vane.

9. A vane according to claim 1 in which a said cove and lip are provided on only one side of the vane.
